(19) United States
(12) Patent Application Publication
(10) Pub. No.: US 2019/0143370 A1
(43) Pub. Date: May 16, 2019

(54) Mitigating Current At Startup Of Ultrasonics

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 16/160,292

(22) Filed: Oct. 15, 2018

Related U.S. Application Data
(60) Provisional application No. 62/584,180, filed on Nov. 10, 2017.

(51) Int. Cl. B06B 1/02

(52) U.S. Cl. CPC B06B 1/023; B06B 2201/40; B06B 2201/71; B06B 2201/73; B06B 2201/72

(57) ABSTRACT

Methods of mitigating current overload of an ultrasonic system having an ultrasonic stack under load at startup are provided. The methods include beginning an ultrasonic cycle in the ultrasonic system having the ultrasonic stack that runs a closed loop phase control through the weld cycle by ramping up the power of the ultrasonic stack under load. During ramping up of the power of the ultrasonic stack under load, a controller lowers the phase to a negative phase. After ramping up the power of the ultrasonic stack under load is complete, the controller raises the phase to 0 degrees and the ultrasonic stack is operating at steady state and with the phase at 0 degrees.

### CROSS-REFERENCE TO RELATED APPLICATIONS

This application claims the benefit of U.S. Provisional Application No. 62/584,180 filed on Nov. 10, 2017. The entire disclosure of the above application is incorporated herein by reference.

### FIELD

The present disclosure relates to the mitigation of current at startup of ultrasonics applications.

### BACKGROUND

This section provides background information related to the present disclosure which is not necessarily prior art.

Common among typical ultrasonic apparatuses include a piezoelectric powered ultrasonic stack excited by an ultrasonic power supply, which is often further used to control the ultrasonic apparatus. The ultrasonic stack includes an ultrasonic converter and any components ultrasonically coupled to the ultrasonic converter, where typically an ultrasonic booster is attached to the ultrasonic converter and an ultrasonic horn is attached to the ultrasonic booster. The ultrasonic power supply drives the ultrasonic converter by providing the requisite electrical excitation.

FIG. 1 shows a model of an ultrasonic stack 102 and ultrasonic power supply 104 of a typical ultrasonic device 100. It should be understood that ultrasonic device 100 can be any type of ultrasonic device that has an ultrasonic stack excited by an ultrasonic power supply. Typical components of ultrasonic stack 102 include an ultrasonic converter 106, a booster 108 and an ultrasonic horn 110. It should be appreciated that not every ultrasonic stack 102 includes booster 108. It should be further appreciated that not every ultrasonic stack 102 includes ultrasonic horn 110. Ultrasonic horn 110 will often have one or more ultrasonic horn tips (not shown). Booster 108 and ultrasonic horn 110 are ultrasonically connected (directly or via another component) to ultrasonic converter 106.

In the example of FIG. 1, booster 108 is mounted to ultrasonic converter 106 ultrasonically connecting booster 108 to ultrasonic converter 106, and ultrasonic horn 110 is mounted to booster 108 ultrasonically connecting ultrasonic horn 110 to booster 108, and thus ultrasonically connecting ultrasonic horn 110 to ultrasonic converter 106 via booster 108. It should be understood that ultrasonic converters are also known in the art as ultrasonic transducers and these terms are used interchangeably.

Ultrasonic power supply 104 is controlled by a controller 114 that includes memory 116. It should be understood that controller 114 can be included in ultrasonic power supply 104 or separate from ultrasonic power supply 104. Controller 114 includes a root mean square (“RMS”) converter module and a control feedback controller including an error signal module (such as an adder) and control module 118, which may be implemented in control logic in controller 114, such as in software or firmware (though these controls can also be embedded in mechanical hardware, electrical digital hardware, electrical analog hardware, software, firmware, or any combination thereof). Ultrasonic device 100 will often include an anvil 122 on which a work piece to be processed will be supported and contacted by the ultrasonic horn tip(s) when it is being processed. For example, if two metal or plastic parts 124 are being welded together, they are supported on anvil 122 and pressed together by the ultrasonic horn tip(s) during the weld process as actuator 120 moves ultrasonic stack 102 and/or anvil 122 relative to the two parts 124 where the horn tip also ultrasonically vibrates against one of the parts to ultrasonically weld the two parts 124 together.

In piezoelectric powered ultrasonic stacks, the RMS amplitude of the motional voltage and the RMS amplitude of the motional current that excite the ultrasonic converter are proportional to the RMS amplitude of the mechanical excitation at the end of the ultrasonic stack in air when the motional voltage and motional current are in phase with each other—that is, when the phase difference between the motional current and the motional current is zero. Unless otherwise stated, as used herein the terms motional voltage and motional current mean the motional voltage and motional current that excite the ultrasonic converter, which are each approximate sinusoidal waveforms. Also, as used herein, phase is the phase difference between the voltage and current waveforms unless the context dictates otherwise. An ultrasonic stack generally runs at a phase of negative 60 to 70 degrees in air when no closed loop phase control is applied in air and negative 90 degrees when its motion is impeded. A negative phase means that the current waveform is leading the voltage waveform and a positive phase means that the voltage waveform is leading the current waveform. A closed loop phase control drives the phase to a requested value. In typical ultrasonic applications, the desired value of the phase is zero, as it is desirable to have the amplitude at full value while the ultrasonic horn is doing its processing. It is thus common practice to control the RMS amplitude of mechanical excitation at the end of the ultrasonic stack by controlling the RMS amplitude of the motional voltage or the RMS amplitude of the motional current.

It should be understood that peak to peak amplitude and /or zero to peak amplitude can be used instead of RMS amplitude in the aforementioned and subsequent discussions.

At startup in ultrasonics applications under load where power in the ultrasonic stack is being ramped up (e.g., heavy stack load or load transients), the amplitude of the RMS current in many instances increases significantly above the amplitude of the RMS current used during steady state operation once the power in the ultrasonic stack has been ramped up. As used herein, steady state operation means the phase, RMS amplitude of the motional voltage, and RMS amplitude of the motional current are unchanging. In such situations, a current overload of the ultrasonic power supply can occur if the ultrasonic power supply is not capable of carrying such a current (e.g., if the ultrasonic power supply is rated for a particular wattage below what occurs at startup under load). Using multiple power supplies and/or using power supplies capable of carrying higher wattages than what are required for steady state operation can prevent current overloads. These approaches are inefficient, however, as they result in users purchasing additional power supplies and/or power supplies rated for higher-wattage than the wattage necessary during steady state ultrasonic application. Notably, these current overloads of the ultrasonic power supply are independent of the RMS voltage. And these current overloads are inherent with ultrasonic power supplies that use closed loop controls to maintain a zero phase between the voltage and current. It is desirable to prevent such current overloads. Further, there is a continuing need to increase efficiency of ultrasonic applications where the application is started under load, such as by decreasing the overall power requirement of an ultrasonic power supply.

### SUMMARY

This section provides a general summary of the disclosure, and is not a comprehensive disclosure of its full scope or all of its features.

In accordance with an aspect of the present disclosure, a method of mitigating current overload of an ultrasonic system having an ultrasonic stack under load at startup is provided. The method includes beginning an ultrasonic cycle in the ultrasonic system having the ultrasonic stack that runs a closed loop phase control through the weld cycle by ramping up the power of an ultrasonic stack under load. During ramping up of the power of the ultrasonic stack under load, the phase is lowered by a controller to a negative phase. After ramping up of the power of the ultrasonic stack under load is complete, the controller raises the phase to 0 degrees and operates the ultrasonic stack at steady state and with the phase at 0 degrees.

According to an aspect, the ultrasonic system is used for welding, cutting, swaging, staking, agitation, cleaning, or drilling.

In accordance with another aspect of the present disclosure, an ultrasonic system comprises an ultrasonic power supply, an ultrasonic stack, and a controller. The ultrasonic power supply is capable of supplying ultrasonic power to an ultrasonic stack under load at startup for weld cycle applications that run a closed loop phase control. The ultrasonic power supply is further capable of ramping up the power supplied to the ultrasonic stack at the beginning of the weld cycle. A controller is capable of controlling the phase of the ultrasonic stack and is configured to lower the phase of the ultrasonic stack below 0 degrees when ramping up the power of the ultrasonic stack under load. The controller is further configured to, after ramping up of the ultrasonic stack under load is complete, raise the phase to 0 degrees and operate the ultrasonic stack at steady state and with the phase at 0 degrees for the duration of the weld cycle.

According to an, the ultrasonic system is an ultrasonic welder, an ultrasonic cutter, an ultrasonic swaging machine, an ultrasonic staking machine, an ultrasonic agitator, an ultrasonic cleaner, or an ultrasonic driller.

According to an aspect, in any of the foregoing aspects the closed loop phase control comprises a P control, I control, PI control, PID control, State Space Control, Kalman Filter, Sliding Mode control, or Bang Bang control.

According to an aspect, in any of the foregoing aspects lowering the phase includes lowering the phase to a negative phase in the range of negative 1 degrees to negative 90 degrees.

According to an aspect, in any of the foregoing aspects, the controller is configured to lower the phase of the ultrasonic stack in the range of −1 degrees to −90 degrees when ramping up the power of the ultrasonic stack.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic view showing a prior art ultrasonic system and prior art control of an ultrasonic power supply that excites a piezoelectric powered ultrasonic stack of the ultrasonic system;

FIG. 2 is a diagrammatic view showing a power supply having current mitigation during ultrasonic ramp up under load;

FIG. 3 is a plot showing ultrasonic ramp up under load without overcurrent mitigation; and

FIG. 4 is a plot showing ultrasonic ramp up under load with overcurrent mitigation using methods according to the present disclosure.

Corresponding reference numerals indicate corresponding parts throughout the several views of the drawings.

### DETAILED DESCRIPTION

Example embodiments will now be described more fully with reference to the accompanying drawings.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

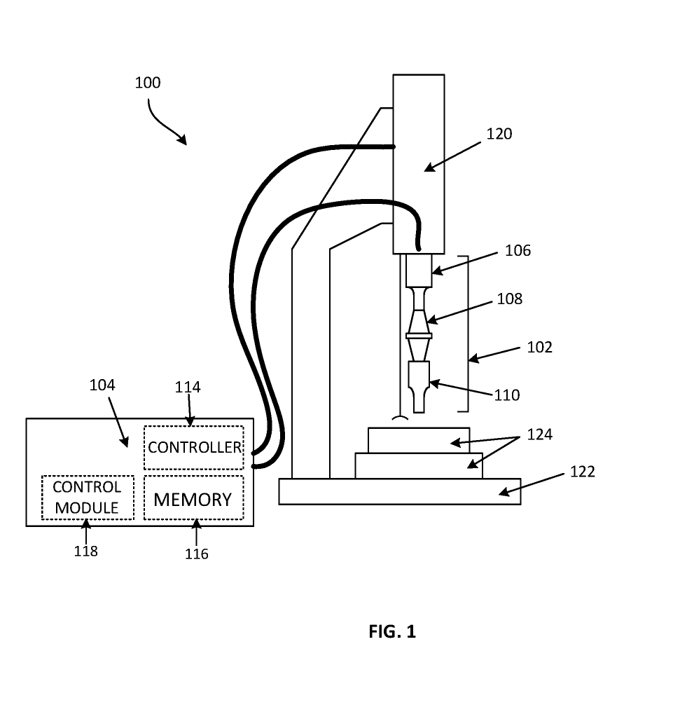

The following discussion will be with reference to ultrasonic device 100 of FIG. 1, but it should be understood that the following applies to any ultrasonic device used for welding, cutting, swaging, staking, agitation, cleaning, drilling, or any other process that needs ultrasonics and is capable of exhibiting closed loop controls. In this regard, it should be understood that the method of mitigating current overload of an ultrasonic power supply during startup of an ultrasonic stack in accordance with an aspect of the present disclosure as described below differs from methods used in prior art ultrasonic devices and the indication that FIG. 1 is prior art does not mean that the below described method is in the prior art. Further, as noted above, ultrasonic stack 102 may or may not comprise either or both of booster 108 or ultrasonic horn 110.

As noted above, it is desirable to prevent current overloads of the ultrasonic power supply. But oftentimes with the startup of ultrasonic applications under load, the amplitude of the RMS current increases to a high level, which can result in a current overload of the ultrasonic power supply. Such current overloads of the ultrasonic power supply are known to occur during a startup ramp-up of the ultrasonic power in the ultrasonic stack, and are independent of the RMS voltage. Further, these current overloads are inherent with ultrasonic power supplies that use closed loop controls to maintain a zero phase between the voltage and current. As noted above, there is a countervailing interest to keep this phase at zero.

The reason for the high current levels can be seen by the following: at steady state, the power consumed by the ultrasonic horn when a force is exerted on the horn is:

Power∝A*F*f (1)

Where:

A=RMS amplitude at end of ultrasonic horn

F=force exerted on horn

f=frequency of ultrasonic horn

But:

A∝V*cos(φ) (2)

Where:

ϕ=phase between I and V

I=RMS current of ultrasonic power supply

V=RMS voltage of ultrasonic power supply

But:

Power=I*V (3)

So by Equations 1, 2, and 3, the following relationship is seen:

I*V∝A*F*f∝V*cos(φ)*F*f∝Power (4)

Factoring out the common variable V in equation 4 provides the following:

I∝cos(φ)*F*f (5)

As noted above, Equation 5 is independent of the RMS voltage. RMS voltage control alone therefore will not reduce the RMS current when the ultrasonic stack is operating at steady state. Also as noted above, while the ultrasonic horn is doing its processing it is desirable, if not required, to have the phase between the voltage and current at zero. The current consumed at steady state under a given force is a level of current needed to be supplied by the power supply.

That all said, because a typical ultrasonic horn has a quality factor of greater than about 100 in some applications and in others greater than or equal to about 1000 at steady state, when the energy of the horn is ramping up at startup, the power needed is governed by Equation 1. During ramping up, the power levels are higher than they would be at steady state because the latent energy of the horn must be built up. This means that the current seen in Equation 5 during ramping up is larger than that experienced during steady state operation of the ultrasonic stack and therefore is at a higher level than is needed during steady state operation. This can lead to current overload of the ultrasonic power supply at startup when the horn is under load unless prophylactic measures are taken, such as using multiple power supplies or having an ultrasonic power supply having a current rating higher than necessary at steady state.

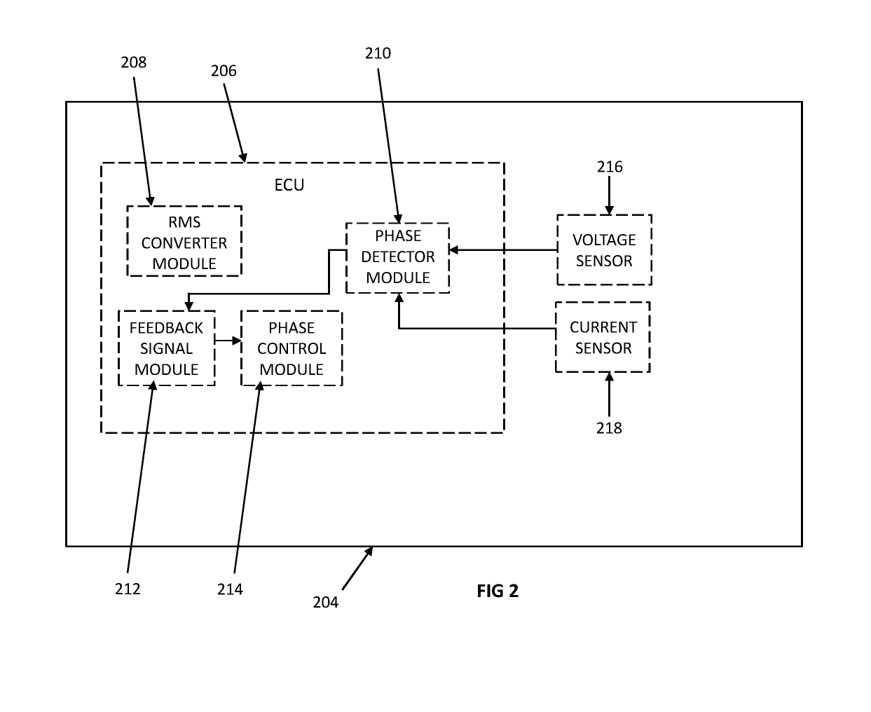

Accordingly, with reference to FIG. 2, providing current mitigation at the startup of ultrasonics is disclosed. A controller, such as electronic control unit (“ECU”) 206 has control logic that implements RMS converter module 208, phase detector module 210, feedback signal module 212, and phase control module 214 through software, firmware, or the like.

While ECU 206 is illustratively shown as residing in ultrasonic power supply 204, ECU 206 may reside separately therefrom. Further, it should be understood that any or all of RMS converter module 208, phase detector module 210, feedback signal module 212, and phase control module 214 could be separate modules.

A voltage sensor 216 is coupled to output of ultrasonic power supply 204 and senses an output voltage of ultrasonic power supply 204, and a current sensor 218 is also coupled to output of ultrasonic power supply 204 that senses an output current of ultrasonic power supply 204. RMS converter module 208 calculates the RMS voltage based on the output voltage detected by voltage sensor 216 and, and RMS converter module 208 also calculates the RMS current based on the output current detected by current sensor 218. Phase detector module 210 detects a phase difference angle between the output voltage and the output current of ultrasonic power supply 204 and this phase difference angle is relayed to the feedback signal module 212 of ECU 206. Feedback signal module 212 instructs phase control module 214 to adjust the phase as warranted. According to some aspects, phase control module 214 adjusts the phase automatically to a phase less than −1 degrees to greater than −90 degrees at the start of an ultrasonic cycle having an ultrasonic stack under load. Once the ultrasonic stack reaches an appropriate power level, the phase control module adjusts the phase to zero.

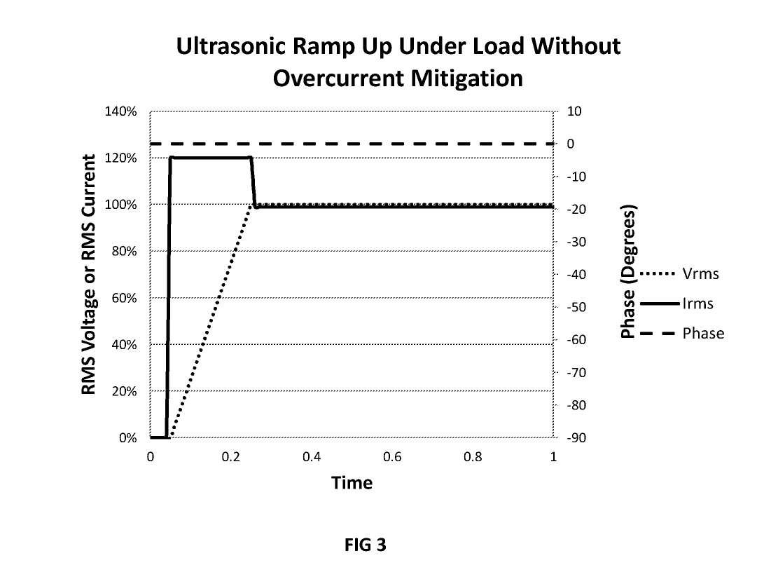

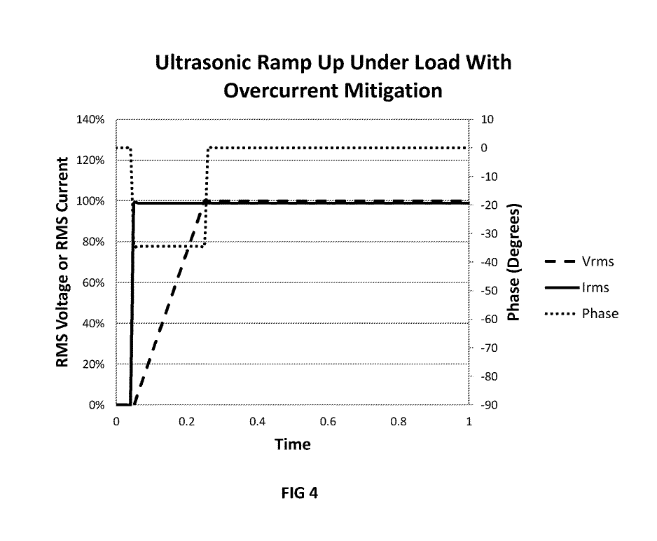

By way of example, reference to FIGS. 3 and 4 are made. Turning first to FIG. 3, which illustrates ultrasonic ramp-up under load without overcurrent mitigation, the RMS voltage (“Vrms”), RMS current (“Irms”), and phase are plotted as a function of time. During ramp-up of an ultrasonic stack under load, the phase is kept at 0 degrees. The Irms, however, increases to 120%, i.e., at a level 20% greater than is required for steady-state operation. If the ultrasonic power supply is rated just to have 100% of the power needed for steady state operation, a power overload results. Referring to FIG. 4, which illustrates ultrasonic ramp-up under load with overcurrent mitigation in accordance with an aspect of the present disclosure, as with FIG. 3, the Vrms, Irms, and phase is plotted as a function of time. During ramp-up of an ultrasonic stack under load, the phase is reduced to about −30 degrees (e.g., by phase control module 214). This reduction in phase correspondingly reduces the Irms. Once the ultrasonic stack is ramped up to steady state, the phase is returned to 0 degrees (e.g., by phase control module 214). Notably, during ramp up, the Irms does not go above 100%, thereby preventing a power overload. While the example shown in FIG. 4 shows achieving an Irms of 100% by reducing the phase to about −30 degrees, it should be noted that a suitable Irms may be achieved by reducing the phase from greater than −90 degrees to less than −1 degrees, depending on applicable parameters defining what a suitable Irms is for a particular ramp-up of an ultrasonic stack under load.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. Appropriate closed loop controls include P, I, PI, and/or PID controls; State Space Controls; Kalman Filters; Sliding Mode controls; Bang Bang Controls; and/or any other control that uses feedback to control the phase. When it is stated that such a device performs a function, it should be understood that the device is configured to perform the function by appropriate logic, such as software, hardware, or a combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of mitigating current overload of an ultrasonic system having an ultrasonic stack under load at startup, the method comprising:
beginning an ultrasonic cycle in the ultrasonic system having the ultrasonic stack that runs a closed loop phase control through the weld cycle by ramping up the power of the ultrasonic stack under load;
during ramping up of the power of the ultrasonic stack under load lowering via a controller the phase to a negative phase; and
after ramping up of the power of the ultrasonic stack under load is complete raising via the controller the phase to 0 degrees and operating the ultrasonic stack at steady state and with the phase at 0 degrees.

2. The method of claim 1, wherein the closed loop phase control comprises a P control, I control, PI control, PID control, State Space Control, Kalman Filter, Sliding Mode control, or Bang Bang control.

3. The method of claim 1, wherein the ultrasonic system is used for welding, cutting, swaging, staking, agitating, cleaning, or drilling.

4. The method of claim 1, wherein lowering the phase includes lowering the phase to a negative phase in the range of −1 degrees to −90 degrees.

5. An ultrasonic system, the ultrasonic system comprising:
an ultrasonic power supply for supplying ultrasonic power to an ultrasonic stack under load at startup that runs a closed loop phase control through a weld cycle and for ramping up the power supplied to the ultrasonic stack at the beginning of the weld cycle; and
a controller for controlling the phase of the ultrasonic stack, wherein the controller is configured to lower the phase of the ultrasonic stack below 0 degrees when ramping up the power of the ultrasonic stack under load, and wherein the controller is configured to, after ramping up of the power of the ultrasonic stack under load is complete, raise the phase to 0 degrees and operate the ultrasonic stack at steady state and with the phase at 0 degrees for the duration of the ultrasonic cycle.

6. The ultrasonic system of claim 5, wherein the closed loop phase control comprises a P control, I control, PI control, PID control, State Space Control, Kalman Filter, Sliding Mode control, or Bang Bang control.

7. The ultrasonic system of claim 5, wherein the ultrasonic system is an ultrasonic welder, an ultrasonic cutter, an ultrasonic swaging machine, an ultrasonic staking machine, an ultrasonic agitator, an ultrasonic cleaner, or an ultrasonic driller.

8. The ultrasonic system of claim 5, wherein the controller is configured to lower the phase of the ultrasonic stack in the range of −1 degrees to −90 degrees when ramping up the power of the ultrasonic stack.
